(19) United States
(12) Patent Application Publication
(10) Pub. No.: US 2009/0308154 A1
(43) Pub. Date: Dec. 17, 2009

(54) Fuel Cartridge Structure with Sensor Apparatus

(75) Inventors: Ming Yao Dong, ChuPei City (TW); Yung Lieh Chien, ChuPei City (TW); Zhi Cheng Chen, ChuPei City (TW); Ming Yi Wang, ChuPei City (TW)

Correspondence Address: NIKOLAI & MERSEREAU, P.A., 900 SECOND AVENUE SOUTH, SUITE 820, MINNEAPOLIS, MN, 55402, US

(73) Assignee: SYSPOTEK CORPORATION, ChuPei City, HsinChu (TW)

(21) Appl. No.: 12/341,577

(22) Filed: Dec. 22, 2008

(30) Foreign Application Priority Data
Jun. 12, 2008 (TW) 097210386

(51) Int. Cl. G01F 23/00

(52) U.S. Cl. 73/290 R

(57) ABSTRACT

The present invention relates to a fuel cartridge structure with sensor apparatus, comprising a main fuel solution tank provided with a casing with accommodation space, the accommodation space being used for storing the fuel solution; and a sensor apparatus mainly having two sensor components, the two sensor components being disposed on exterior surface or in the structure of the casing of the main fuel solution tank for achieving the objective of measurement.

### FIELD OF THE INVENTION

The present invention relates to a fuel cartridge structure with sensor apparatus, and more particularly, to the fuel cartridge structure with sensor apparatus wherein related physical phenomenon of solution in a main fuel solution tank can be measured.

### BACKGROUND OF THE INVENTION

Conventional fluid level measuring devices measure the fluid quantity. Fluid measuring devices are generally sizable and complex in structure, and hence more costly. However there is increasingly market demand for small-size and low-cost products. Take the example of fuel cell system, its applications in portable electronic devices are picking up. In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the fluid fuel level and volume in the fuel container. Such detection work is typically achieved through expensive metering sensor, which is rather uneconomical when used extensively in portable electrical products.

Furthermore, measuring apparatus on the market is mostly disposed in a fuel tank and in contact with the fuel solution which is often corrosive. Thus the sensor apparatus often might become inaccurate or even loses function completely because of the corrosiveness. Meanwhile, the sensor component is in direct contact with the fuel fluid that causes great electrical safety concern during the detection. In light of the drawbacks of conventional fluid measuring devices, the inventor with many years of experience in the industry aims to develop an improved fluid measuring device that effectively achieves the objects.

### SUMMARY OF THE INVENTION

The present invention relates to a fuel cartridge structure with sensor apparatus, and more particularly, to the fuel cartridge structure with sensor apparatus wherein related physical phenomenon of solution in a main fuel solution tank can be measured.

The present invention relates to a fuel cartridge structure with sensor apparatus, comprising a main fuel solution tank provided with a casing with accommodation space, the accommodation space being used for storing the fuel solution; and a sensor apparatus mainly having two sensor components, the two sensor components being disposed on exterior surface or in the structure of the casing of the main fuel solution tank for achieving the objective of measurement.

The objects, features and effects of the invention are described in detail below with embodiments in reference to the accompanying drawings.

### BRIEF DESCRIPTION OF THE DRAWINGS

FIG. 1 is a component diagram of the first preferred embodiment of the invention.

FIG. 2 is a perspective component diagram of the first preferred embodiment of the invention.

FIG. 3 is a perspective component diagram of the second preferred embodiment of the invention.

FIG. 4 is a component diagram of the third preferred embodiment of the invention.

FIG. 5 is a perspective component diagram of the third preferred embodiment of the invention.

FIG. 6 is a component diagram of the fourth preferred embodiment of the invention.

FIG. 7 is a perspective component diagram of the fourth preferred embodiment of the invention.

FIG. 8 is a perspective component diagram of the fifth preferred embodiment of the invention.

FIG. 9 is a component diagram of the sixth preferred embodiment of the invention.

FIG. 10 is a perspective component diagram of the sixth preferred embodiment of the invention.

### DETAILED DESCRIPTION OF THE INVENTION

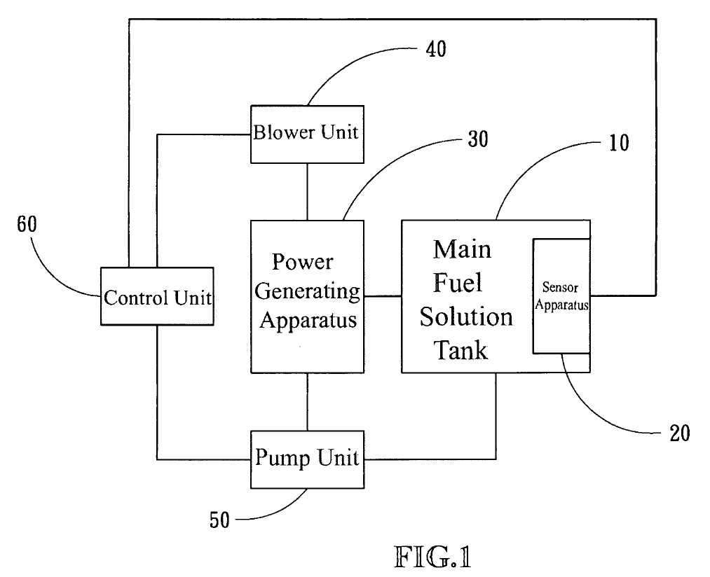

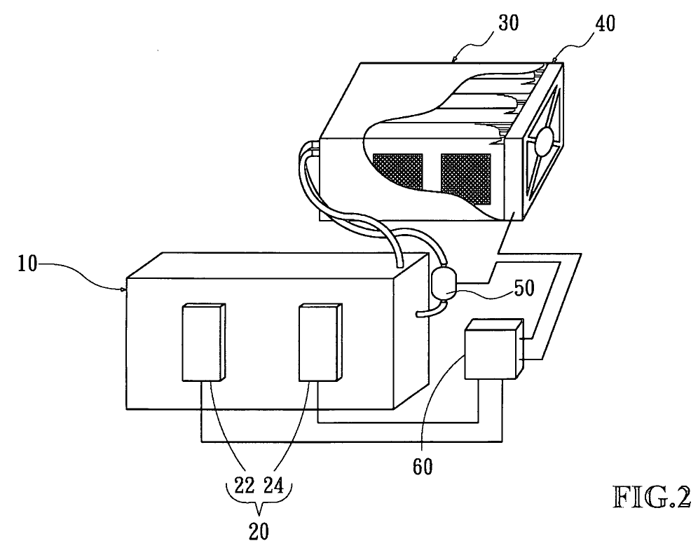

Referring to FIG. 1 and FIG. 2, FIG. 1 is the component diagram of the first preferred embodiment of the invention, and FIG. 2 is the perspective component diagram of the first preferred embodiment of the invention. The present invention relates to a fuel cartridge structure with metering sensor apparatus, comprising a main fuel solution tank (10), a sensor apparatus (20), a power generating apparatus (30), a blower unit (40), a pump unit (50) and a control unit (60). The embodiment of the invention is described in detail as below.

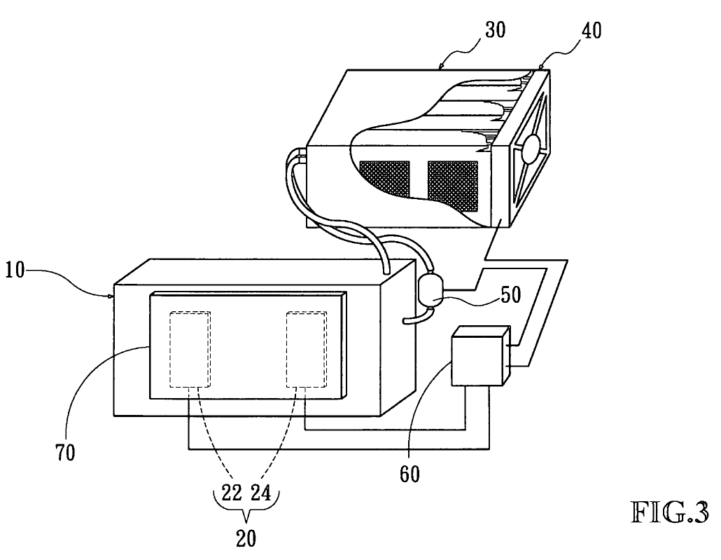

The main fuel solution tank (10) comprises a casing provided with accommodation space, and the accommodation space is for storing fuel solution. The sensor apparatus (20) mainly has two sensor components (22, 24), and one of the two sensor components (22, 24) is mainly for detecting signal and the other is mainly for grounding. The two sensor components (22, 24) are disposed on the external surface of the same side of the casing of the main fuel solution tank (10). The two sensor components (22, 24) are mainly made of conductive metal materials such as copper, aluminum, iron and so on. A protection layer (not shown in the figure) can be disposed on the external surface of the casing of the main fuel solution tank (10) for preventing external signals from interfering with the measurement of the two sensor components (22, 24). Or, the one of two sensor components (22, 24) for grounding can be disposed outside of the other one for detecting, so that the objective of preventing the interference of external signals can be achieved. The two sensor components (22, 24) can further be disposed on the same substrate (70) in advance (as shown in FIG. 3). The substrate (70) is disposed on the external surface of the casing of the main fuel solution tank (10). A protection layer (not shown in the figure) can also be disposed on the external surface of the substrate (70) for preventing external signals from interfering with the measurement of the two sensor components (22, 24). Or, the one of two sensor components (22, 24) for grounding can be disposed outside of the other one for detecting, so that the objective of preventing the interference of external signals can also be achieved.

The power generating apparatus (30) is a direct methanol fuel cell (DMFC) and is a fuel cell structure of a base layer PCB, further comprising the blower unit (40) and the pump unit (50). The blower unit (40) is mainly a fan apparatus for providing gaseous oxygen fuel needed by the electrochemical reaction of the power generating apparatus (30), and providing the cooling of the power generating apparatus (30). The pump unit (50) is mainly a fluid driving apparatus for driving the fluid between the main fuel solution tank (10) and the power generating apparatus (30), wherein the solution of the main fuel solution tank (10) is connected with the power generating apparatus (30) through a pipeline assembly. The control unit (60) is composed of a chip and circuit means, and has logic means, signal output and input means for controlling the blower unit (40) and the pump unit (50).

For example, the main fuel solution tank (10) is a fuel solution storage container for storing fuel in the fuel cell system. There is a solution in the main fuel solution tank (10), and the main fuel solution tank (10) is disposed on the external surface of the same side of the casing of the main fuel solution tank (10), so that the fluid level of the solution, solution density, solution concentration or other solution characteristic can be measured, and the received message can be transmitted to the control unit (60). When the solution characteristic of the main fuel solution tank (10) changes, the two sensor components (22, 24) of the sensor apparatus (20) can detect such change and a message is transmitted to the control unit (60) through the connector, for taking possible inaccuracy into consideration.

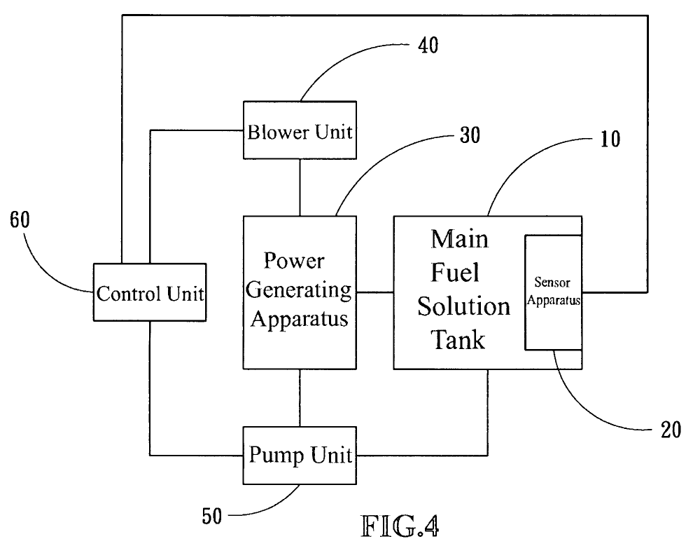

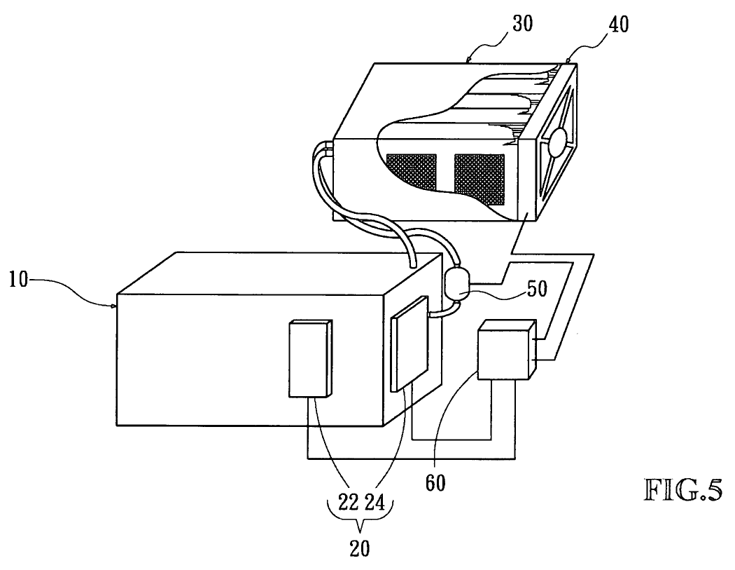

Referring to FIG. 4 and FIG. 5, FIG. 4 is the component diagram of the third preferred embodiment of the invention, and FIG. 5 is the perspective component diagram of the third preferred embodiment of the invention. The present invention relates to a fuel cartridge structure with metering sensor apparatus, comprising a main fuel solution tank (10), a sensor apparatus (20), a power generating apparatus (30), a blower unit (40), a pump unit (50) and a control unit (60). The embodiment of the invention is described in detail as below.

The main fuel solution tank (10) comprises a casing provided with accommodation space, and the accommodation space is for storing fuel solution. The sensor apparatus (20) mainly has two sensor components (22, 24). The two sensor components (22, 24) are disposed on the external surface of the different sides of the casing of the main fuel solution tank (10), such as adjacent sides or opposite sides (adjacent sides are taken as example in the embodiment). The two sensor components (22, 24) are mainly made of conductive metal materials such as copper, aluminum, iron and so on. A protection layer (not shown in the figure) can be disposed on the external surface of the casing of the main fuel solution tank (10) for preventing external signals from interfering with the measurement of the two sensor components (22, 24).

The power generating apparatus (30) is a direct methanol fuel cell (DMFC) and is a fuel cell structure of a base layer PCB, further comprising the blower unit (40) and the pump unit (50). The blower unit (40) is mainly a fan apparatus for providing gaseous oxygen fuel needed by the electrochemical reaction of the power generating apparatus (30), and providing the cooling of the power generating apparatus (30). The pump unit (50) is mainly a fluid driving apparatus for driving the fluid between the main fuel solution tank (10) and the power generating apparatus (30), wherein the solution of the main fuel solution tank (10) is connected with the power generating apparatus (30) through a pipeline assembly. The control unit (60) is composed of a chip and circuit means, and has logic means, signal output and input means for controlling the blower unit (40) and the pump unit (50).

For example, the main fuel solution tank (10) is a fuel solution storage container for storing fuel in the fuel cell system. There is a solution in the main fuel solution tank (10), and the main fuel solution tank (10) is disposed on the external surface of different sides of the casing of the main fuel solution tank (10), such as adjacent sides or opposite sides (adjacent sides are taken as example in the embodiment), so that the fluid level of the solution, solution density, solution concentration or other solution characteristic can be measured, and the received message can be transmitted to the control unit (60). When the solution characteristic of the main fuel solution tank (10) changes, the two sensor components (22, 24) of the sensor apparatus (20) can detect such change and a message is transmitted to the control unit (60) through the connector, for taking possible inaccuracy into consideration.

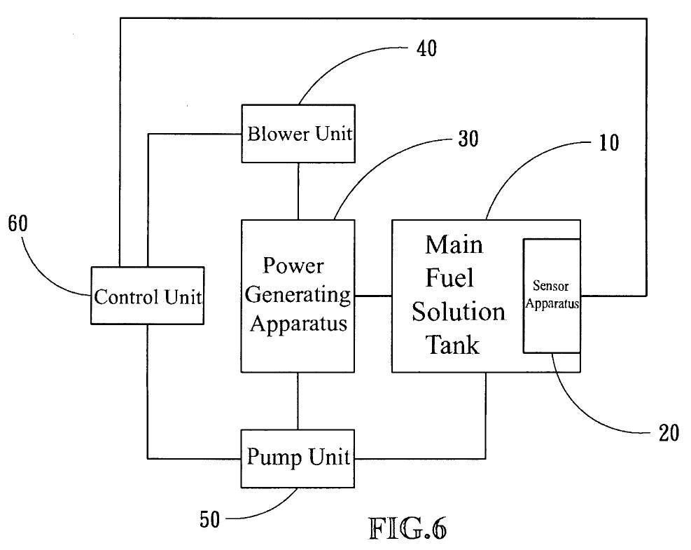

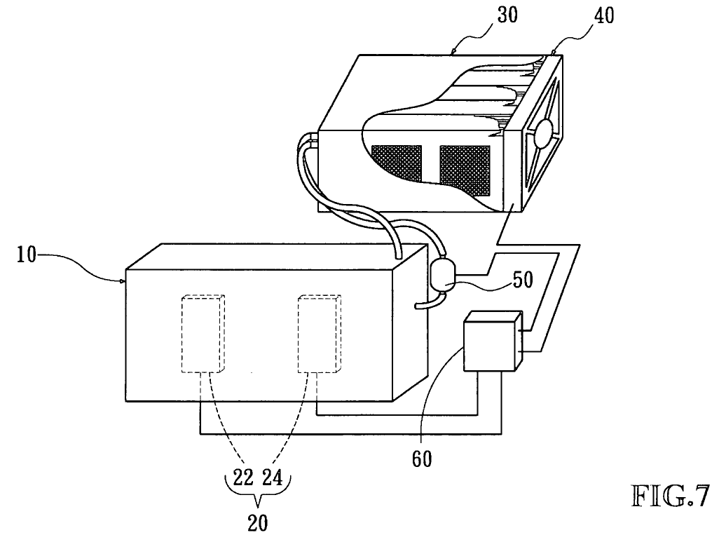

Referring to FIG. 6 and FIG. 7, FIG. 6 is the component diagram of the fourth preferred embodiment of the invention, and FIG. 7 is the perspective component diagram of the fourth preferred embodiment of the invention. The present invention relates to a fuel cartridge structure with metering sensor apparatus, comprising a main fuel solution tank (10), a sensor apparatus (20), a power generating apparatus (30), a blower unit (40), a pump unit (50) and a control unit (60). The embodiment of the invention is described in detail as below.

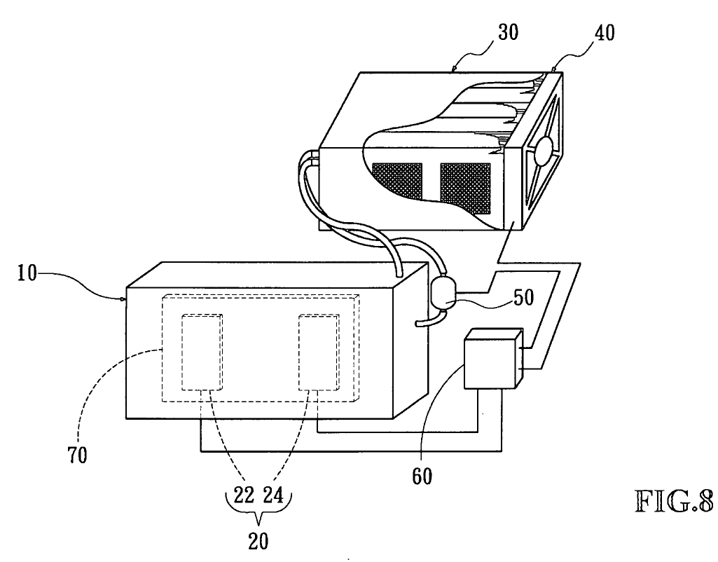

The main fuel solution tank (10) comprises a casing provided with accommodation space, and the accommodation space is for storing fuel solution. The sensor apparatus (20) mainly has two sensor components (22, 24), and one of the two sensor components (22, 24) is mainly for detecting signal and the other is mainly for grounding. The two sensor components (22, 24) are disposed in the structure of the same side of the casing of the main fuel solution tank (10). The two sensor components (22, 24) are mainly made of conductive metal materials such as copper, aluminum, iron and so on. A protection layer (not shown in the figure) can be disposed on the external surface of the casing of the main fuel solution tank (10) for preventing external signals from interfering with the measurement of the two sensor components (22, 24). Or, the one of two sensor components (22, 24) for grounding can be disposed outside of the other one for detecting, so that the objective of preventing the interference of external signals can be achieved. The two sensor components (22, 24) can further be disposed on the same substrate (70) in advance (as shown in FIG. 8). The substrate (70) is disposed on the external surface of the casing of the main fuel solution tank (10). A protection layer (not shown in the figure) can also be disposed on the external surface of the substrate (70) for preventing external signals from interfering with the measurement of the two sensor components (22, 24). Or, the one of two sensor components (22, 24) for grounding can be disposed outside of the other one for detecting, so that the objective of preventing the interference of external signals can also be achieved.

The power generating apparatus (30) is a direct methanol fuel cell (DMFC) and is a fuel cell structure of a base layer PCB, further comprising a blower unit (40) and the pump unit (50). The blower unit (40) is mainly a fan apparatus for providing gaseous oxygen fuel needed by the electrochemical reaction of the power generating apparatus (30), and providing the cooling of the power generating apparatus (30). The pump unit (50) is mainly a fluid driving apparatus for driving the fluid between the main fuel solution tank (10) and the power generating apparatus (30), wherein the solution of the main fuel solution tank (10) is connected with the power generating apparatus (30) through a pipeline assembly. The control unit (60) is composed of a chip and circuit means, and has logic means, signal output and input means for controlling the blower unit (40) and the pump unit (50).

For example, the main fuel solution tank (10) is a fuel solution storage container for storing fuel in the fuel cell system. There is a solution in the main fuel solution tank (10), and the main fuel solution tank (10) is disposed in the structure of the same side of the casing of the main fuel solution tank (10), so that the fluid level of the solution, solution density, solution concentration or other solution characteristic can be measured, and the received message can be transmitted to the control unit (60). When the solution characteristic of the main fuel solution tank (10) changes, the two sensor components (22, 24) of the sensor apparatus (20) can detect change and a signal is transmitted to the control unit (60) through the connector, for taking possible inaccuracy into consideration.

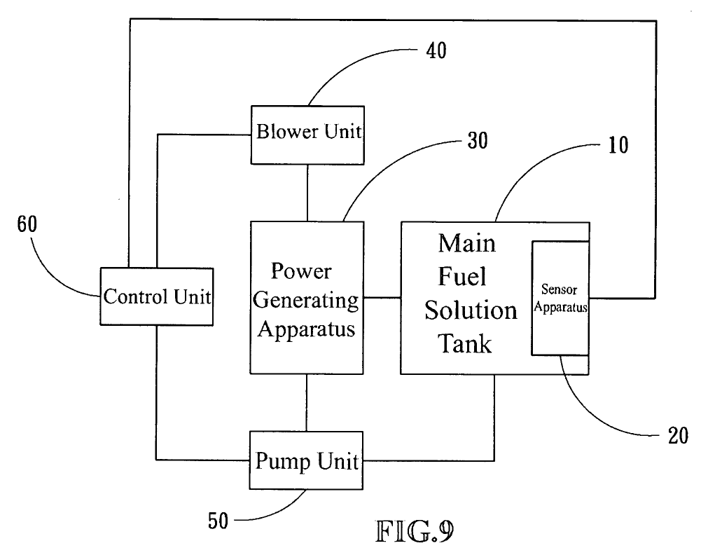

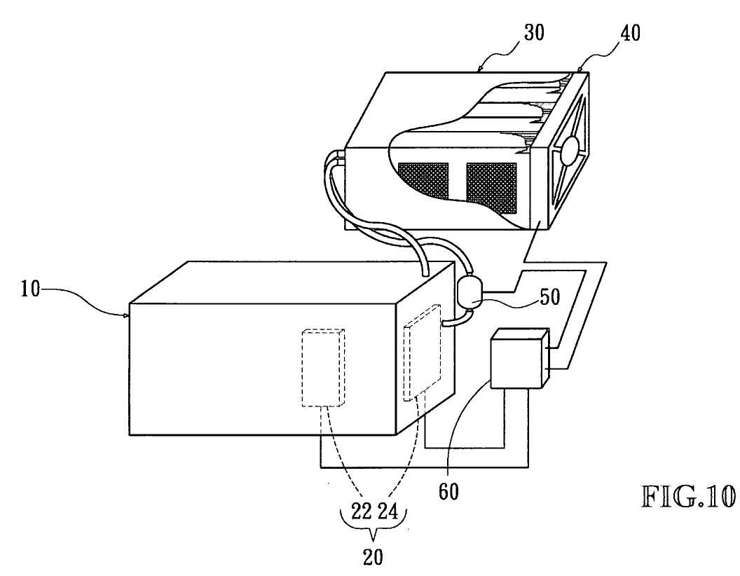

Referring to FIG. 9 and FIG. 10, FIG. 9 is the component diagram of the sixth preferred embodiment of the invention, and FIG. 10 is the perspective component diagram of the sixth preferred embodiment of the invention. The present invention relates to a fuel cartridge structure with metering sensor apparatus, comprising a main fuel solution tank (10), a sensor apparatus (20), a power generating apparatus (30), a blower unit (40), a pump unit (50) and a control unit (60). The embodiment of the invention is described in detail as below.

The main fuel solution tank (10) comprises a casing provided with accommodation space, and the accommodation space is for storing fuel solution. The sensor apparatus (20) mainly has two sensor components (22, 24). The two sensor components (22, 24) are disposed in the structure of the different sides of the casing of the main fuel solution tank (10), such as adjacent sides or opposite sides (adjacent sides are taken as example in the embodiment). The two sensor components (22, 24) are mainly made of conductive metal materials such as copper, aluminum, iron and so on. A protection layer (not shown in the figure) can be disposed on the external surface of the casing of the main fuel solution tank (10) for preventing external signals from interfering with the measurement of the two sensor components (22, 24).

The power generating apparatus (30) is a direct methanol fuel cell (DMFC) and is a fuel cell structure of a base layer PCB, further comprising the blower unit (40) and the pump unit (50). The blower unit (40) is mainly a fan apparatus for providing gaseous oxygen fuel needed by the electrochemical reaction of the power generating apparatus (30), and providing the cooling of the power generating apparatus (30). The pump unit (50) is mainly a fluid driving apparatus for driving the fluid between the main fuel solution tank (10) and the power generating apparatus (30), wherein the solution of the main fuel solution tank (10) is connected with the power generating apparatus (30) through a pipeline assembly. The control unit (60) is composed of a chip and circuit means, and has logic means, signal output and input means for controlling the blower unit (40) and the pump unit (50).

For example, the main fuel solution tank (10) is a fuel solution storage container for storing fuel in the fuel cell system. There is a solution in the main fuel solution tank (10), and the main fuel solution tank (10) is disposed in the structure of different sides of the casing of the main fuel solution tank (10), such as adjacent sides or opposite sides (adjacent sides are taken as example in the embodiment), so that the fluid level of the solution, solution density, solution concentration or other solution characteristic can be measured, and the received message can be transmitted to the control unit (60). When the solution characteristic of the main fuel solution tank (10) changes, the two sensor components (22, 24) of the sensor apparatus (20) can detect such change and a message is transmitted to the control unit (60) through the connector, for taking possible inaccuracy into consideration.

Thereby, the invention provides a fuel cartridge structure with sensor apparatus for measuring related physical phenomenon of solution in the main fuel solution tank. Thus, the invention possesses inventive step and meets the essential criteria for new utility patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A fuel cartridge structure with sensor apparatus, comprising:
a main fuel solution tank, comprising a casing provided with accommodation space, the accommodation space being for storing fuel solution; and
a sensor apparatus, comprising two sensor components, one of the two sensor components being mainly for measuring signal, the other being mainly for grounding, the two sensor components being disposed on external surface of the casing of the main fuel solution tank.

2. The fuel cartridge structure with sensor apparatus according to claim 1, further comprising a power generating apparatus, the solution of tie main fuel solution tank being connected with the power generating apparatus through a pipeline assembly.

3. The fuel cartridge structure with sensor apparatus according to claim 2, wherein the power generating apparatus further comprises a blower unit, a pump unit and a control unit.

4. The fuel cartridge structure with sensor apparatus according to claim 1, wherein the two sensor components are disposed on the same side or different sides of the casing.

5. The fuel cartridge structure with sensor apparatus according to claim 4, wherein the two sensor components disposed on the same side are on a same substrate and the substrate is disposed on an external surface of the casing of the main fuel solution tank.

6. The fuel cartridge structure with sensor apparatus according to claim 5, wherein a protection layer is disposed on an external surface of the substrate or the casing of the main fuel solution tank.

7. The fuel cartridge structure with sensor apparatus according to claim 4, wherein when the two sensor components are on the same side, the two sensor components are stacked up and the sensor component for grounding is disposed outside while the sensor component for signal detection is disposed inside.

8. The fuel cartridge structure with sensor apparatus according to claim 5, wherein when the two sensor components are on the substrate, the two sensor components are stacked up and the sensor component for grounding is disposed outside the substrate while the sensor component for signal detection is disposed inside the substrate.

9. A fuel cartridge structure with sensor apparatus, comprising:
a main fuel solution tank, comprising a casing provided with accommodation space, the accommodation space being for storing fuel solution; and
a sensor apparatus, comprising two sensor components, one of the two sensor components being mainly for measuring signal, the other being mainly for grounding, the two sensor components being disposed in structure of the casing of the main fuel solution tank.

10. The fuel cartridge structure with sensor apparatus according to claim 9, further comprising a power generating apparatus, the solution of the main fuel solution tank being connected with the power generating apparatus through a pipeline assembly.

11. The fuel cartridge structure with sensor apparatus according to claim 10, wherein the power generating apparatus further comprises a blower unit, a pump unit and a control unit.

12. The fuel cartridge structure with sensor apparatus according to claim 9, wherein the two sensor components are disposed on the same side or different sides of the casing.

13. The fuel cartridge structure with sensor apparatus according to claim 12, wherein the two sensor components disposed on the same side are on a same substrate and the substrate is disposed in structure of the casing of the main fuel solution tank.

14. The fuel cartridge structure with sensor apparatus according to claim 13, wherein a protection layer is disposed on an external surface of the substrate or the casing of the main fuel solution tank.

15. The fuel cartridge structure with sensor apparatus according to claim 12, wherein when the two sensor components are on the same side, the two sensor components are stacked up and the sensor component for grounding is disposed outside while the sensor component for signal detection is disposed inside.

16. The fuel cartridge structure with sensor apparatus according to claim 13, wherein when the two sensor components are on the substrate, the two sensor components are stacked up and the sensor component for grounding is disposed outside the substrate while the sensor component for signal detection is disposed inside the substrate.
